(19) United States
(12) Patent Application Publication
(10) Pub. No.: US 2026/0187435 A1
(43) Pub. Date: Jul. 2, 2026

(54) ARTIFICIAL INTELLIGENCE DEVICE AND ITS NEURAL NETWORK PROCESSING UNIT AND OPERATION METHOD

(71) Applicant: Novatek Microelectronics Corp., Hsinchu (TW)

(72) Inventors: Cheng-Che Tsai, Taichung City (TW); Yu-Ting Lin, Taichung City (TW); Yuan-Po Cheng, Hsinchu County (TW)

(73) Assignee: Novatek Microelectronics Corp., Hsinchu (TW)

(21) Appl. No.: 19/005,984

(22) Filed: Dec. 30, 2024

(51) Int. Cl. G06N 3/063; G06F 12/0875

(52) U.S. Cl. CPC G06N 3/063; G06F 12/0875

(57) ABSTRACT

The disclosure provides an artificial intelligence (AI) device, a neural network processing unit (NPU), and an operation method. The AI device includes a host circuit, a memory, and the NPU. The NPU is coupled to the host circuit and the memory. The NPU establishes a transmission connection to the host circuit. A model weight set of an AI model includes a first weight subset and a second weight subset. During an initialization period before the NPU executes the AI model, the host circuit preloads the first weight subset into the memory. During an execution period when the NPU executes the AI model, the NPU receives the first weight subset from the memory and the second weight subset from the host circuit for executing the AI model.

### BACKGROUND

### Technical Field

The disclosure relates to an electronic circuit, and particularly relates to an artificial intelligence (AI) device and its neural network processing unit (NPU) and operation method.

### Description of Related Art

Since different AI applications require different weights, before a NPU calculates an AI model, a pre-compiled model weight set (trained weight data) is transmitted to a memory. During an execution period when the NPU calculates the AI model, a plurality of weight data for the entire model weight set are provided from the memory to the NPU at different times. Based on the memory model weight set, the NPU performs neural network calculation processing on the input data (such as feature tensors) provided by the host circuit during the execution period.

During the execution period when the NPU calculates the AI model, the NPU will frequently read the weight data required for the AI model operation from the memory. In detail, the AI model generally includes a plurality of computing layers. The NPU needs to use corresponding weight data when executing each operation. Generally speaking, the NPU needs to wait for the corresponding weight data to be read before it may start the current operation. Depending on the AI model architecture, the NPU may need to read a large amount of weight data from the memory instantly. At this time, the bandwidth of the memory will be the bottleneck of the NPU processing speed.

It should be noted that the content of the “Description of Related Art” paragraph is used to help understand the disclosure. Some of the content (or all of the content) disclosed in the “Description of Related Art” paragraph may not be known by persons skilled in the art. The content disclosed in the “Description of Related Art” paragraph does not mean that the content has been known to persons skilled in the art before the application of the disclosure.

### SUMMARY

The disclosure provides an artificial intelligence (AI) device and its neural network processing unit (NPU) and operation method for calculating an AI model.

In an embodiment of the disclosure, the AI device includes a host circuit, a memory, and the NPU. The NPU is coupled to the host circuit and the memory. The NPU establishes a transmission connection to the host circuit. A model weight set of the AI model includes a first weight subset and a second weight subset. During an initialization period before the NPU executes the AI model, the host circuit preloads the first weight subset into the memory. During an execution period when the NPU executes the AI model, the NPU receives the first weight subset from the memory and the second weight subset from the host circuit for executing the AI model.

In an embodiment of the disclosure, the NPU includes an interface circuit, a weight cache, and an operation circuit. The interface circuit is used to establish a transmission connection to the host circuit. The weight cache is coupled to the interface circuit. The operation circuit is coupled to the weight cache. The model weight set of the AI model includes the first weight subset and the second weight subset. During an initialization period before the operation circuit executes the AI model, the host circuit preloads the first weight subset into the memory. During an execution period when the operation circuit executes the AI model, the weight cache receives the first weight subset from the memory and the second weight subset from the host circuit through the interface circuit, so as to provide the model weight set to the operation circuit for executing the AI model.

In an embodiment of the disclosure, the operation method of the NPU includes: establishing the transmission connection from the interface circuit of the NPU to the host circuit, wherein the interface circuit is coupled to the weight cache of the NPU, the weight cache is coupled to the operation circuit of the NPU, the model weight set of the AI model includes the first weight subset and the second weight subset, and the first weight subset is preloaded into the memory by the host circuit during the initialization period before the operation circuit executes the AI model; and during the execution period when the operation circuit executes the AI model, receiving the first weight subset from the memory by the weight cache and receiving the second weight subset from the host circuit through the interface circuit by the weight cache, so as to provide the model weight set to the operation circuit for executing the AI model.

In an embodiment of the disclosure, the AI device includes a host circuit, a memory, and the NPU. The NPU is coupled to the host circuit and the memory. The NPU establishes a transmission connection to the host circuit. the NPU selectively operates in one of a weight transmission bandwidth saving mode and a weight transmission normal mode. In the weight transmission normal mode, the host circuit preloads a model weight set of the AI model into a memory during an initialization period before the NPU executes the AI model. In the weight transmission normal mode, the NPU receives the model weight set from the memory for executing the AI model during an execution period when the NPU executes the AI model. In the weight transmission bandwidth saving mode, the model weight set of the AI model comprises a first weight subset and a second weight subset, and the host circuit preloads the first weight subset into the memory during the initialization period before the NPU executes the AI model. In the weight transmission bandwidth saving mode, the NPU receives the first weight subset from the memory and receives the second weight subset from the host circuit for executing the AI model during the execution period when the NPU executes the AI model.

In an embodiment of the disclosure, the NPU is configured to calculate an artificial intelligence (AI) model. The NPU selectively operates in one of a weight transmission bandwidth saving mode and a weight transmission normal mode. The NPU includes an interface circuit, a weight cache, and an operation circuit. The interface circuit is configured to establish a transmission connection to a host circuit. The weight cache is coupled to the interface circuit. The operation circuit is coupled to the weight cache. In the weight transmission normal mode, the host circuit preloads a model weight set of the AI model into a memory during an initialization period before the operation circuit executes the AI model. In the weight transmission normal mode, during an execution period when the operation circuit executes the AI model, the weight cache receives the model weight set from the memory, so as to provide the model weight set to the operation circuit for executing the AI model. In the weight transmission bandwidth saving mode, the model weight set of the AI model comprises a first weight subset and a second weight subset, and the host circuit preloads the first weight subset into the memory during the initialization period before the operation circuit executes the AI model. In the weight transmission bandwidth saving mode, during the execution period when the operation circuit executes the AI model, the weight cache receives the first weight subset from the memory and receives the second weight subset from the host circuit through the interface circuit, so as to provide the model weight set to the operation circuit for executing the AI model.

In an embodiment of the disclosure, the operation method of the NPU includes: establishing a transmission connection from an interface circuit of the NPU to a host circuit, wherein the interface circuit is coupled to a weight cache of the NPU, the weight cache is coupled to an operation circuit of the NPU, the NPU selectively operates in one of a weight transmission bandwidth saving mode and a weight transmission normal mode, a model weight set of the AI model is preloaded into a memory by the host circuit during an initialization period before the operation circuit executes the AI model in the weight transmission normal mode, the model weight set of the AI model comprises a first weight subset and a second weight subset in the weight transmission bandwidth saving mode, and the first weight subset is preloaded into a memory by the host circuit during the initialization period before the operation circuit executes the AI model in the weight transmission bandwidth saving mode; receiving the model weight set from the memory by the weight cache, so as to provide the model weight set to the operation circuit for executing the AI model during an execution period when the operation circuit executes the AI model in the weight transmission normal mode; and receiving the first weight subset from the memory by the weight cache, and receiving the second weight subset from the host circuit through the interface circuit by the weight cache, so as to provide the model weight set to the operation circuit for executing the AI model during the execution period when the operation circuit executes the AI model in the weight transmission bandwidth saving mode.

Based on the above, the first weight subset of the model weight set is preloaded into the memory during the initialization period. During the execution period of the AI model, a part of the model weight set (the first weight subset) is transmitted from the memory to the weight cache, while another part of the model weight set (the second weight subset) is transmitted from the host circuit to the weight cache. That is, during the execution period of the AI model, in addition to providing the input data (such as feature tensors) of the AI model to the NPU, the host circuit also provides the second weight subset to the NPU. Based on the model weight set provided by the cooperation of the host circuit and the memory, the NPU performs calculation processing (computes the AI model) on the input data provided by the host circuit during the execution period.

In order to make the above-mentioned features and advantages of the disclosure clearer and easier to understand, the following embodiments are given and described in details with accompanying drawings as follows.

### BRIEF DESCRIPTION OF THE DRAWINGS

FIG. 1 is a schematic circuit block diagram of an artificial intelligence (AI) device according to an embodiment.

FIG. 2 is a schematic diagram of an operation timing of an NPU according to an embodiment.

FIG. 3 is a schematic circuit block diagram of an AI device according to an embodiment of the disclosure.

FIG. 4 is a schematic flowchart of an operation method of an NPU according to an embodiment of the disclosure.

FIG. 5 is a schematic diagram of an operation timing of the NPU according to an embodiment.

### DESCRIPTION OF THE EMBODIMENTS

The word “coupled to (or connected to)” as used throughout this specification (including the scope of the application) may refer to any direct or indirect means of connection. For example, if it is described in the specification that a first device is coupled (or connected) to a second device, it should be construed that the first device may be directly connected to the second device, or the first device may be indirectly connected to the second device through another device or some type of connecting means. The terms “first” and “second” and the like mentioned in the full text (including the scope of the patent application) of the description of this application are used only to name the elements or to distinguish different embodiments or scopes and are not intended to limit the upper or lower limit of the number of the elements, nor is it intended to limit the order of elements. Also, where possible, elements/components/steps using the same reference numerals in drawings and embodiments represent the same or similar parts. Elements/components/steps that use the same reference numerals or use the same terminology in different embodiments may refer to relative descriptions of each other.

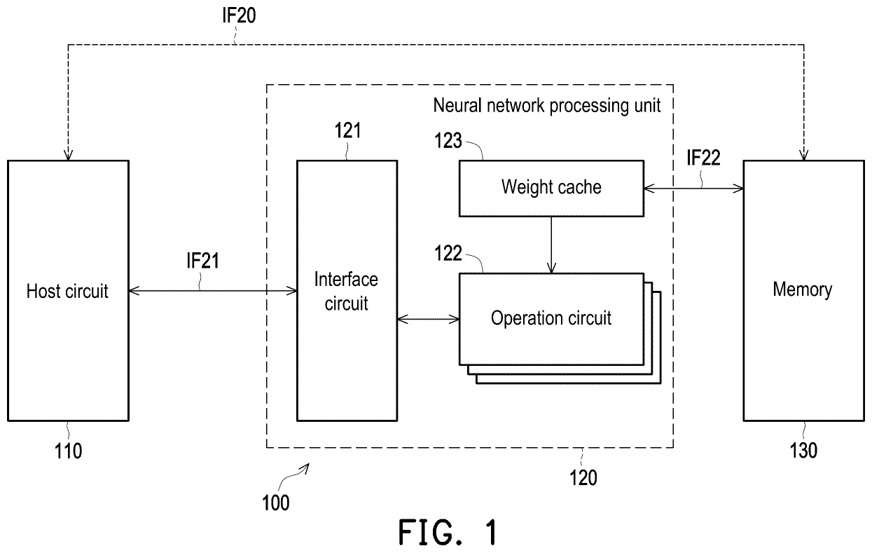

FIG. 1 is a schematic circuit block diagram of an artificial intelligence (AI) device 100 according to an embodiment. The AI device 100 is used to calculate an AI model. Based on different designs, the AI device 100 may be a smart phone, a tablet, a personal computer, or other devices. The AI device 100 includes a host circuit 110, a neural network processing unit (NPU) 120, and a memory 130. Based on actual design and application, the host circuit 110 includes a central processing unit (CPU), an application processor (AP), a graphics processing unit (GPU), or other host circuits, and the memory 130 may include any type of random-access memory (RAM), for example, a double data rate synchronous dynamic RAM (DDR SDRAM) or other types of random-access memory.

The neural network processing unit 120 is coupled to the host circuit 110 and the memory 130. The neural network processing unit 120 establishes a transmission connection IF21 to the host circuit 110. Based on actual design and application, the transmission connection IF21 includes a display serial interface (DSI) that complies with the Mobile Industry Processor Interface (MIPI) specification. In other application examples, the transmission connection IF21 may be other transmission interfaces.

The NPU 120 is used to calculate the AI model. Since different AI models require different weights, during the initialization period before the NPU 120 executes the AI model, the host circuit 110 will first preload the entire pre-compiled model weight set (trained weight data) into the memory 130 through a transmission connection IF20. During the execution period when the NPU 120 executes the AI model, a plurality of weight data for the entire model weight set are provided to the NPU 120 from the memory 130 through a transmission connection IF22 at different times. Based on the model weight set in the memory 130, the NPU 120 performs neural network calculation processing on the input data (e.g., feature tensors) provided by the host circuit 110 during the execution period. During the execution period when the NPU 120 calculates the AI model, the NPU 120 will frequently read the weight data required for the AI model operation from the memory 130 through the transmission connection IF22.

In detail, the AI model generally includes a plurality of computing layers. The NPU 120 needs to use corresponding weight data when executing each operation of the AI model. Generally speaking, the NPU 120 needs to wait for the corresponding weight data to be read from the memory 130 before it may start executing the current operation. Depending on the AI model architecture, the NPU 120 may need to read a large amount of weight data from the memory 130 instantly.

In the embodiment shown in FIG. 1, the NPU 120 includes an interface circuit 121, an operation circuit 122, and a weight cache 123. The interface circuit 121 is used to establish the transmission connection IF21 to the host circuit 110. The operation circuit 122 is coupled to the interface circuit 121 and the weight cache 123. During the execution period when the operation circuit executes the AI model, the weight cache 123 receives the model weight set from the memory 130 through the transmission connection IF22, and the operation circuit 122 receives the input data (such as feature tensors) from the host circuit 110 through the interface circuit 121.

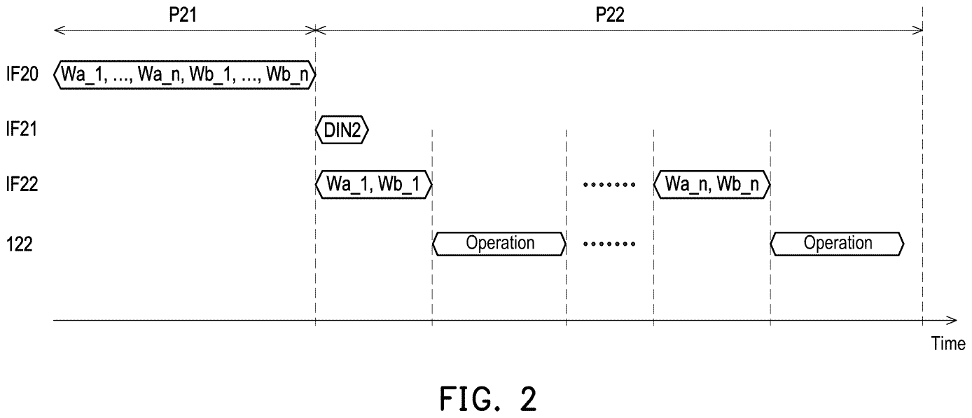

FIG. 2 is a schematic diagram of an operation sequence of the NPU 120 according to an embodiment. The horizontal axis of FIG. 2 represents time. Referring to FIG. 1 and FIG. 2, during an initialization period P21 before the operation circuit 122 executes the AI model, the host circuit 110 will first preload the entire model weight set (such as weight data Wa_1, . . . , Wa_n, Wb_1, . . . , Wb_n shown in FIG. 2) into the memory 130 through the transmission connection IF20. During an execution period P22 when the NPU 120 executes the AI model, a plurality of weight data for the entire model weight set are provided to the weight cache 123 from the memory 130 through the transmission connection IF22 at different times. Based on the model data of the weight cache 123, during the execution period, the operation circuit 122 may perform neural network calculation processing on input data DIN2 (e.g., feature tensors) provided by the host circuit 110 through the transmission connection IF21. During the execution period P22 when the operation circuit 122 calculates the AI model, the weight cache 123 will frequently read the weight data required for AI model operation from the memory 130 through the transmission connection IF22 (such as the weight data Wa_1, Wb_1, Wa_n, and Wb_n shown in FIG. 2). Each of the weight data Wa_1, Wb_1, Wa_n, and Wb_n shown in FIG. 2 may represent one or more weights, and the data type of the weight may be a real number, a vector, a matrix, a tensor, or other data types.

The weight cache 123 may include any type of cache memory, such as a static RAM (SRAM) or other types of cache memory. Due to cost considerations, the weight cache 123 has a limited capacity and generally may not accommodate the entire model weight set. Therefore, part of the weight data of the model weight set in the memory 130 (such as the weight data Wa_1 and Wb_1 shown in FIG. 2) is first stored in the weight cache 123 for use in the current operation. The operation circuit 122 obtains the weight data corresponding to a certain operation (current operation) of the AI model from the weight cache 123 to perform the current operation. After completing the current operation, the operation circuit 122 may store the operation result of the current operation in an intermediate data buffer (not shown) for use in other operations of the AI model. Each “operation” of the operation circuit 122 shown in FIG. 2 may represent one or more operations of the AI model. After all operations of the AI model are completed, the operation circuit 122 may transmit the output data of the AI model back to the host circuit 110 through the interface circuit 121.

Generally speaking, the operation circuit 122 needs to wait for the corresponding weight data (such as the weight data Wa_1 and Wb_1 shown in FIG. 2) to be read from the memory 130 to the weight cache 123 before the operation circuit 122 may start to perform the current operation. Depending on the AI model architecture, the weight cache 123 may need to instantly read a large amount of weight data from the memory 130 through the transmission connection IF22. At this time, the bandwidth of the memory 130 (the bandwidth of the transmission connection IF22) will be the bottleneck of the processing speed of the NPU 120. The following embodiment will illustrate how to share the transmission load of the transmission connection IF22 between the memory 130 and the weight cache 123.

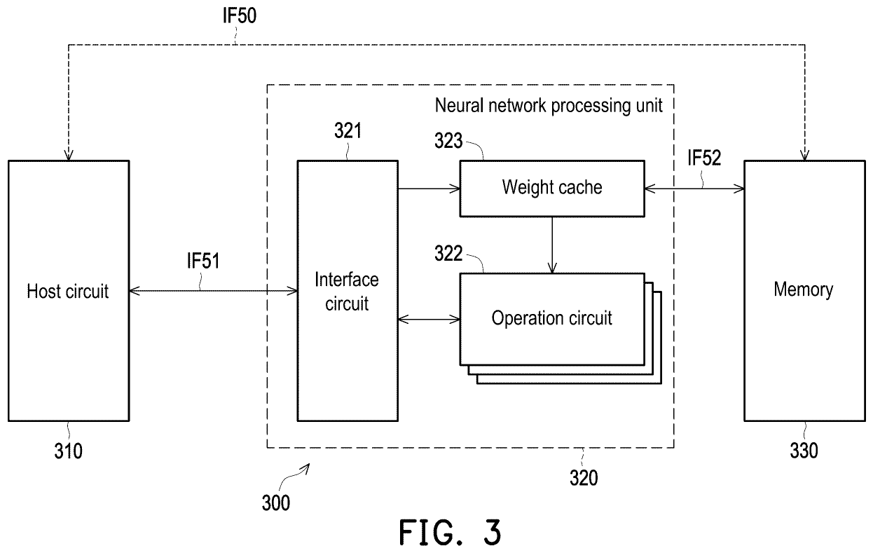

FIG. 3 is a schematic circuit block diagram of an AI device 300 according to an embodiment of the disclosure. The AI device 300 includes a host circuit 310, an NPU 320, and a memory 330. The AI device 300, the host circuit 310, the NPU 320, the memory 330, a transmission connection IF50, a transmission connection IF51, and a transmission connection IF52 shown in FIG. 3 may be deduced with reference to the related description of the AI device 100, the host circuit 110, the NPU 120, the memory 130, the transmission connection IF20, the transmission connection IF21, and the transmission connection IF22 shown in FIG. 1, therefore it is not repeated herein.

In the embodiment shown in FIG. 3, the model weight set of the AI model includes a first weight subset and a second weight subset. During the initialization period before the NPU 320 executes the AI model, the host circuit 310 preloads the first weight subset into the memory 330 through the transmission connection IF50 (the second weight subset may not be preloaded into the memory 330). The transmission connection IF50 may be any data transmission interface. For example, in some embodiments, the transmission connection IF50 may include a direct memory access (DMA) interface or other data transmission interfaces. During the execution period when the NPU 320 executes the AI model, the NPU 320 receives the first weight subset from the memory 330 and the NPU 320 receives the second weight subset from the host circuit 310 to perform many operations of the AI model.

In the embodiment shown in FIG. 3, the NPU 320 includes an interface circuit 321, an operation circuit 322, and a weight cache 323. The interface circuit 321, the operation circuit 322, and the weight cache 323 shown in FIG. 3 may be deduced with reference to the related description of the interface circuit 121, the operation circuit 122, and the weight cache 123 shown in FIG. 1, and therefore it is not repeated herein. According to different designs, in some embodiments, the implementation of the interface circuit 321 and/or the operation circuit 322 may be a hardware circuit. In other embodiments, the implementation of the interface circuit 321 and/or the operation circuit 322 may be a combination of hardware, firmware, and software (i.e., program).

In terms of hardware, the interface circuit 321 and/or the operation circuit 322 may be implemented as a logic circuit on an integrated circuit. For example, the related functions of the interface circuit 321 and/or the operation circuit 322 may be implemented in one or more hardware controllers, microcontrollers, hardware processors, microprocessors, application-specific integrated circuits (ASICs), digital signal processors (DSPs), field programmable gate arrays (FPGAs), CPUs, and/or various logic blocks, modules, and circuits in other processing units. The related functions of the interface circuit 321 and/or the operation circuit 322 may be implemented as hardware circuits, such as various logic blocks, modules, and circuits in integrated circuits, using hardware description languages (such as Verilog HDL or VHDL) or other suitable programming languages.

In terms of software form and/or firmware form, the related functions of the interface circuit 321 and/or the operation circuit 322 may be implemented as programming codes. For example, general programming languages (such as C, C++, or assembly language) or other suitable programming languages are used to implement the interface circuit 321 and/or the operation circuit 322. The programming code may be recorded/stored in a “non-transitory machine-readable storage medium”. In some embodiments, the non-transitory machine-readable storage medium includes, for example, a semiconductor memory and/or a storage device. An electronic device (such as a CPU, a hardware controller, a microcontroller, a hardware processor, or a microprocessor) may read and execute the programming code from the non-transitory machine-readable storage medium, thereby realizing the related functions of the interface circuit 321 and/or the operation circuit 322.

Different from the weight cache 123 shown in FIG. 1, the weight cache 323 shown in FIG. 3 is also coupled to the interface circuit 321. During the execution period of the AI model, the weight cache 323 receives the first weight subset from the memory 330, and the weight cache 323 receives the second weight subset from the host circuit 310 through the interface circuit 321, so the weight cache 323 may provide the model weight set to the operation circuit 322 to perform many operations of the AI model.

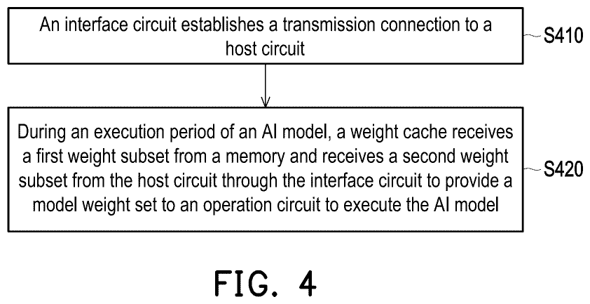

FIG. 4 is a schematic flowchart of an operation method of an NPU according to an embodiment of the disclosure. Referring to FIG. 3 and FIG. 4, in step S410, the interface circuit 321 establishes the transmission connection IF51 to the host circuit 310. The transmission connection IF51 may be any data transmission interface. For example, in some embodiments, the transmission connection IF51 may include an MIPI interface or other data transmission interfaces. During the execution period when the operation circuit 322 executes the AI model, the weight cache 323 receives the first weight subset from the memory 330, and the weight cache 323 receives the second weight subset from the host circuit 310 through the interface circuit 321, so as to provide the model weight set to the operation circuit 322 for executing many operations of the AI model (step S420).

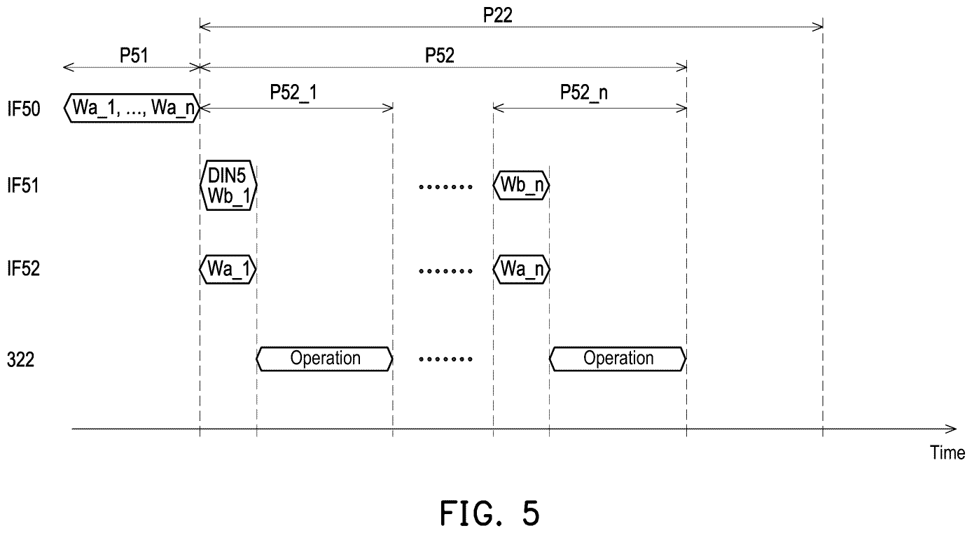

FIG. 5 is a schematic diagram of an operation timing of the NPU 320 according to an embodiment. The horizontal axis of FIG. 5 represents time. In the embodiment shown in FIG. 5, the model weight set of the AI model includes the first weight subset (such as the weight data Wa_1, . . . , Wa_n shown in FIG. 5) and the second weight subset (such as the weight data Wb_1, . . . , Wb_n shown in FIG. 5). Referring to FIG. 3 and FIG. 5, during an initialization period P51 before the operation circuit 322 executes the AI model, the host circuit 310 will first preload part of the data of the model weight set (such as the first weight subset Wa_1 to Wa_n shown in FIG. 5) into the memory 330 through the transmission connection IF50.

At different times during an execution period P52 when the NPU 320 executes the AI model, a plurality of weight data of the first weight subset Wa_1 to Wa_n of the memory 330 are provided to the weight cache 323 through the transmission connection IF52. The transmission connection IF52 may be any data transmission interface. During the execution period P52 when the NPU 320 executes the AI model, the host circuit 310 provides input data DIN5 (such as feature tensors) to the operation circuit 322 through the transmission connection IF51 and the interface circuit 321. Moreover, the host circuit 310 provides a plurality of weight data of the second weight subset Wb_1 to Wb_n to the weight cache 323 at different times through the transmission connection IF51 and the interface circuit 321. Based on actual design and application, the transmission connection IF51 includes a DSI that complies with the MIPI specification, and the interface circuit 321 receives the second weight subset Wb_1 to Wb_n from the host circuit 310 through the DSI operating in an image mode, and writes the second weight subset Wb_1 to Wb_n into the weight cache 323 at different times. Based on the model data of the weight cache 323, the operation circuit 322 may perform neural network calculation processing on the AI model during the execution period P52. Each of the weight data Wa_1 to Wa_n and Wb_1 to Wb_n shown in FIG. 5 may represent one or more weights, and the data type of the weight may be a real number, a vector, a matrix, a tensor, or other data types.

The host circuit 310 prepares in advance the weight data required for the execution of the NPU 320 according to the actual execution timing of the NPU 320, and packages the weight data into a data format that complies with the transmission connection IF51 (such as the image format of MIPI DSI). Based on the data format specification of the transmission connection IF51, dummy data may be packed into the data format of the transmission connection IF51 when no weight data is transmitted. Regarding the distribution of weight data and dummy data, the host circuit 310 will pre-arrange the data according to the execution speed of the NPU 320 and the time point when the NPU 320 needs the data when the AI model is pre-compiled. The host circuit 310 sends the weight data and/or dummy data to the NPU 320 through the transmission connection IF51 interface. The interface circuit 321 parses the data format of the transmission connection IF51 to store the weight data from the transmission connection IF51 into the weight cache 323. Therefore, the host circuit 310 may provide the plurality of weight data of the second weight subset Wb_1 to Wb_n to the weight cache 323 at different times through the transmission connection IF51 and the interface circuit 321.

For example, during an operation period P52_1 in the execution period P52, the weight cache 323 receives at least one first weight in the first weight subset Wa_1 to Wa_n (such as the weight data Wa_1 shown in FIG. 5) from the memory 330 through the transmission connection IF52, and the weight cache 323 receives at least one second weight (such as the weight data Wb_1 shown in FIG. 5) in the second weight subset Wb_1 to Wb_n from the host circuit 310 through the interface circuit 321 and the transmission connection IF51. The operation circuit 322 uses the at least one first weight and the at least one second weight of the weight cache 323 to perform at least one first operation in the AI model. In the same way, during an operation period P52_n in the execution period P52, the weight cache 323 receives at least one third weight (such as the weight data Wa_n shown in FIG. 5) in the first weight subset Wa_1 to Wa_n from the memory 330 through the transmission connection IF52, and the weight cache 323 receives at least one fourth weight (such as the weight data Wb_n shown in FIG. 5) in the second weight subset Wb_1 to Wb_n from the host circuit 310 through the interface circuit 321 and the transmission connection IF51. The operation circuit 322 uses the at least one third weight and the at least one fourth weight of the weight cache 323 to perform at least one second operation in the AI model.

Compared with the execution period P22 shown in FIG. 2, the embodiment shown in FIG. 5 may use the transmission connection IF51 between the host circuit 310 and the NPU 320 to share the transmission load of the transmission connection IF52 between the memory 330 and the weight cache 323. During the execution period P52 of the AI model, a part of the model weight set (the first weight subset Wa_1 to Wa_n) is transmitted from the memory 330 to the weight cache 323, while another part of the model weight set (the second weight subset Wb_1 to Wb_n) is transmitted from the host circuit 310 to the weight cache 323. That is, during the execution period P52 of the AI model, in addition to providing the input data DIN5 (such as feature tensors) of the AI model to the NPU 320, the host circuit 310 also provides the second weight subset Wb_1 to Wb_n to the NPU 320. Based on the model weight set “Wa_1 to Wa_n and Wb_1 to Wb_n” provided by the cooperation of the host circuit 310 and the memory 330, during the execution period P52, the NPU 320 performs calculation processing (computes the AI model) on the input data DIN5 provided by the host circuit 310.

In summary, the first weight subset of the model weight set is preloaded into the memory 330 during the initialization period P51. During the execution period P52 of the AI model, a part of the model weight set (the first weight subset Wa_1 to Wa_n) is transmitted from the memory 330 to the weight cache 323, while another part of the model weight set (the second weight subset Wb_1 to Wb_n) is transmitted from the host circuit 310 to the weight cache 323. That is, during the execution period P52 of the AI model, in addition to providing the input data DIN5 (such as feature tensors) of the AI model to the NPU 320, the host circuit 310 also provides the second weight subset Wb_1 to Wb_n to the NPU 320. Based on the model weight set provided by the cooperation of the host circuit 310 and the memory 330, the NPU 320 performs calculation processing (computes the AI model) on the input data DIN5 provided by the host circuit 310 during the execution period P52.

The operations of the host circuit 310, the NPU 320 and the memory 330 are not limited to the above contents. For example, the NPU 320 may selectively execute the process shown in FIG. 4. For example, if the transmission bandwidth of the memory 330 is sufficient, the host circuit 310 can preload all the model weight set into the memory 330, and the memory 330 provides the entire model weight set to the weight cache 323. In such embodiments, the NPU 320 may selectively operate in one of a weight transmission bandwidth saving mode and a weight transmission normal mode.

In the weight transmission bandwidth saving mode, the operations of the host circuit 310, the NPU 320 and the memory 330 can refer to the relevant contents of the above-mentioned FIG. 4 and FIG. 5, so the details will not be described again. In the weight transmission normal mode, the host circuit 310 preloads all the model weight set of the AI model into the memory 330 during the initialization period before the NPU 320 executes the AI model. In the weight transmission normal mode, the NPU 320 receives the model weight set from the memory 330 during the execution period when the operation circuit 322 executes the AI model, so as to execute the AI model.

For example, in the weight transmission normal mode, the host circuit 310 preloads all the model weight set of the AI model into the memory 330 during the initialization period before the operation circuit 322 executes the AI model, and the weight cache 323 receives the model weight set from memory 330 during the execution period when the operation circuit 322 executes the AI model. Therefore, the weight cache 323 can provide the model weight set to the operation circuit 322 for executing the AI model. In the weight transmission bandwidth saving mode, the operations of the interface circuit 321, the operation circuit 322 and the weight cache 323 can refer to the relevant contents of the above-mentioned FIG. 3 and FIG. 5, so no further description is given.

Although the disclosure has been described with reference to the embodiments above, the embodiments are not intended to limit the disclosure. Any person skilled in the art can make some changes and modifications without departing from the spirit and scope of the disclosure. Therefore, the scope of the disclosure will be defined in the appended claims.

What is claimed is:

1. An artificial intelligence (AI) device configured to calculate an AI model, the AI device comprising:
a host circuit;
a memory; and
a neural network processing unit (NPU) coupled to the host circuit and the memory, wherein the NPU establishes a transmission connection to the host circuit, and a model weight set of the AI model comprises a first weight subset and a second weight subset;
during an initialization period before the NPU executes the AI model, the host circuit preloads the first weight subset into a memory; and
during an execution period when the NPU executes the AI model, the NPU receives the first weight subset from the memory and receives the second weight subset from the host circuit for executing the AI model.

2. The AI device according to claim 1, wherein,
during a first operation period in the execution period, the NPU receives at least one first weight in the first weight subset from the memory and receives at least one second weight in the second weight subset from the host circuit, and the NPU uses the at least one first weight and the at least one second weight to perform at least one first operation in the AI model; and
during a second operation period in the execution period, the NPU receives at least one third weight in the first weight subset from the memory and receives at least one fourth weight in the second weight subset from the host circuit, and the NPU uses the at least one third weight and the at least one fourth weight to perform at least one second operation in the AI model.

3. The AI device according to claim 1, wherein the transmission connection comprises a display serial interface (DSI) that complies with a Mobile Industry Processor Interface specification, and the host circuit transmits the second weight subset to the NPU through the DSI operating in an image mode.

4. The AI device according to claim 1, wherein the NPU comprises:
an interface circuit configured to establish the transmission connection to the host circuit;
a weight cache coupled to the interface circuit; and
an operation circuit coupled to the weight cache, wherein during the execution period, the weight cache receives the first weight subset from the memory and receives the second weight subset from the host circuit through the interface circuit, so as to provide the model weight set to the operation circuit for executing the AI model.

5. The AI device according to claim 4, wherein,
during a first operation period in the execution period, the weight cache receives at least one first weight in the first weight subset from the memory and receives at least one second weight in the second weight subset from the host circuit through the interface circuit, and the operation circuit uses the at least one first weight and the at least one second weight of the weight cache to perform at least one first operation in the AI model; and
during a second operation period in the execution period, the weight cache receives at least one third weight in the first weight subset from the memory and receives at least one fourth weight in the second weight subset from the host circuit through the interface circuit, and the operation circuit uses the at least one third weight and the at least one fourth weight of the weight cache to perform at least one second operation in the AI model.

6. A neural network processing unit (NPU) configured to calculate an artificial intelligence (AI) model, the NPU comprising:
an interface circuit configured to establish a transmission connection to a host circuit;
a weight cache coupled to the interface circuit; and
an operation circuit coupled to the weight cache, wherein a model weight set of the AI model comprises a first weight subset and a second weight subset;
during an initialization period before the operation circuit executes the AI model, the host circuit preloads the first weight subset into a memory; and
during an execution period when the operation circuit executes the AI model, the weight cache receives the first weight subset from the memory and receives the second weight subset from the host circuit through the interface circuit, so as to provide the model weight set to the operation circuit for executing the AI model.

7. The NPU according to claim 6, wherein,
during a first operation period in the execution period, the weight cache receives at least one first weight in the first weight subset from the memory and receives at least one second weight in the second weight subset from the host circuit through the interface circuit, and the operation circuit uses the at least one first weight and the at least one second weight of the weight cache to perform at least one first operation in the AI model; and
during a second operation period in the execution period, the weight cache receives at least one third weight in the first weight subset from the memory and receives at least one fourth weight in the second weight subset from the host circuit through the interface circuit, and the operation circuit uses the at least one third weight and the at least one fourth weight of the weight cache to perform at least one second operation in the AI model.

8. The NPU according to claim 7, wherein the transmission connection comprises a display serial interface (DSI) that complies with a Mobile Industry Processor Interface specification, and the interface circuit receives the second weight subset from the host circuit through the DSI operating in an image mode, and writes the second weight subset into the weight cache.

9. An operation method of a neural network processing unit (NPU), wherein the NPU is configured to calculate an artificial intelligence (AI) model, and the operation method comprises:
establishing a transmission connection from an interface circuit of the NPU to a host circuit, wherein the interface circuit is coupled to a weight cache of the NPU, the weight cache is coupled to an operation circuit of the NPU, a model weight set of the AI model comprises a first weight subset and a second weight subset, and the first weight subset is preloaded into a memory by the host circuit during an initialization period before the operation circuit executes the AI model; and
during an execution period when the operation circuit executes the AI model, receiving the first weight subset from the memory by the weight cache, and receiving the second weight subset from the host circuit through the interface circuit by the weight cache, so as to provide the model weight set to the operation circuit for executing the AI model.

10. The operation method according to claim 9 further comprising:
during a first operation period in the execution period, receiving at least one first weight in the first weight subset from the memory by the weight cache, receiving at least one second weight in the second weight subset from the host circuit through the interface circuit by the weight cache, and using the at least one first weight and the at least one second weight of the weight cache to perform at least one first operation in the AI model by the operation circuit; and
during a second operation period in the execution period, receiving at least one third weight in the first weight subset from the memory by the weight cache, receiving at least one fourth weight in the second weight subset from the host circuit through the interface circuit by the weight cache, and using the at least one third weight and the at least one fourth weight of the weight cache to perform at least one second operation in the AI model by the operation circuit.

11. The operation method according to claim 10, wherein the transmission connection comprises a display serial interface (DSI) that complies with a Mobile Industry Processor Interface specification, and the operation method further comprises:
receiving the second weight subset from the host circuit by the interface circuit through the DSI operating in an image mode; and
writing the second weight subset into the weight cache by the interface circuit.

12. An artificial intelligence (AI) device configured to calculate an AI model, the AI device comprising:
a host circuit;
a memory; and
a neural network processing unit (NPU) coupled to the host circuit and the memory, wherein the NPU establishes a transmission connection to the host circuit, the NPU selectively operates in one of a weight transmission bandwidth saving mode and a weight transmission normal mode;
in the weight transmission normal mode, during an initialization period before the NPU executes the AI model, the host circuit preloads a model weight set of the AI model into a memory;
in the weight transmission normal mode, during an execution period when the NPU executes the AI model, the NPU receives the model weight set from the memory for executing the AI model;
in the weight transmission bandwidth saving mode, the model weight set of the AI model comprises a first weight subset and a second weight subset, and the host circuit preloads the first weight subset into the memory during the initialization period before the NPU executes the AI model; and
in the weight transmission bandwidth saving mode, during the execution period when the NPU executes the AI model, the NPU receives the first weight subset from the memory and receives the second weight subset from the host circuit for executing the AI model.

13. A neural network processing unit (NPU) configured to calculate an artificial intelligence (AI) model, the NPU selectively operating in one of a weight transmission bandwidth saving mode and a weight transmission normal mode, the NPU comprising:
an interface circuit configured to establish a transmission connection to a host circuit;
a weight cache coupled to the interface circuit; and
an operation circuit coupled to the weight cache, wherein
in the weight transmission normal mode, during an initialization period before the operation circuit executes the AI model, the host circuit preloads a model weight set of the AI model into a memory;
in the weight transmission normal mode, during an execution period when the operation circuit executes the AI model, the weight cache receives the model weight set from the memory, so as to provide the model weight set to the operation circuit for executing the AI model;
in the weight transmission bandwidth saving mode, the model weight set of the AI model comprises a first weight subset and a second weight subset, and the host circuit preloads the first weight subset into the memory during the initialization period before the operation circuit executes the AI model; and
in the weight transmission bandwidth saving mode, during the execution period when the operation circuit executes the AI model, the weight cache receives the first weight subset from the memory and receives the second weight subset from the host circuit through the interface circuit, so as to provide the model weight set to the operation circuit for executing the AI model.

14. An operation method of a neural network processing unit (NPU), wherein the NPU is configured to calculate an artificial intelligence (AI) model, and the operation method comprises:
establishing a transmission connection from an interface circuit of the NPU to a host circuit, wherein the interface circuit is coupled to a weight cache of the NPU, the weight cache is coupled to an operation circuit of the NPU, the NPU selectively operates in one of a weight transmission bandwidth saving mode and a weight transmission normal mode, a model weight set of the AI model is preloaded into a memory by the host circuit during an initialization period before the operation circuit executes the AI model in the weight transmission normal mode, the model weight set of the AI model comprises a first weight subset and a second weight subset in the weight transmission bandwidth saving mode, and the first weight subset is preloaded into a memory by the host circuit during the initialization period before the operation circuit executes the AI model in the weight transmission bandwidth saving mode;
in the weight transmission normal mode, during an execution period when the operation circuit executes the AI model, receiving the model weight set from the memory by the weight cache, so as to provide the model weight set to the operation circuit for executing the AI model; and
in the weight transmission bandwidth saving mode, during the execution period when the operation circuit executes the AI model, receiving the first weight subset from the memory by the weight cache, and receiving the second weight subset from the host circuit through the interface circuit by the weight cache, so as to provide the model weight set to the operation circuit for executing the AI model.
